(19) United States
(12) Patent Application Publication
(10) Pub. No.: US 2023/0357573 A1
(43) Pub. Date: Nov. 9, 2023

(54) ENVIRONMENTALLY FRIENDLY POLYMER ADDITIVE COMBINATION

(71) Applicant: Okeanos Group, LLC, Miami Beach, FL (US)

(72) Inventors: Russell Petrie, Irvine, CA (US); Mary Lehrter, Cincinnati, OH (US)

(21) Appl. No.: 18/314,724

(22) Filed: May 9, 2023

Related U.S. Application Data
(60) Provisional application No. 63/364,368, filed on May 9, 2022.

(51) Int. Cl. C08L 89/00; C08K 3/26; C08K 5/11; C08J 7/12

(52) U.S. Cl. CPC C08L 89/005; C08K 3/26; C08K 5/11; C08J 7/123; C08K 2003/265; C08J 2389/00

(57) ABSTRACT

A packaging material and a process of making this material are provided. The material contains an organic additive that promotes oxidative degradation and the subsequent bio-degradation of polyolefin polymers. This material and process are believed to be superior to existing materials and processes in terms of enhancing plastic degradation. The packaging material is formed from a composition that includes calcium carbonate (CaCO₃), a polymer and casein and/or caseinate.

### CROSS-REFERENCE TO RELATED APPLICATION(S)

The present application claims priority to and the benefit of U.S. Provisional Application No. 63/364,368, filed in the United States Patent and Trademark Office on May 9, 2022, the entire content of which is incorporated herein by reference.

### BACKGROUND

Polyolefin polymers may degrade to some extent by oxidation. However, owing to their nature as petroleum-based polymers and the presence of oxidative stabilizers, these polymers do not readily break down in an open environment.

Because of this resistance to breaking down/decomposing, plastic goods remain in the environment for a long time. When these plastic goods eventually break down, they have the potential to create microplastics that can have negative biological effects on plants and animals. It is believed that these breakdown products have a life span similar to that of their parent products.

Developing a way to enhance and control oxidative breakdown and subsequent biological incorporation of the carbon from the polymer chain into a living organism (i.e., bio-degradation) is something that is expected to be of great value to the planet.

### SUMMARY

A packaging material and a process of making this material are described. The material contains an organic additive that promotes oxidative degradation and the subsequent bio-degradation of polyolefin polymers. This material and process are believed to be superior to existing materials and processes in terms of enhancing plastic degradation.

According to one or more embodiments of the present disclosure, a packaging material is formed from a composition that includes calcium carbonate (CaCO₃), a polymer, and casein and/or caseinate. In one or more embodiments, the packaging material further includes calcium propionate (C₆H₁₀CaO₄).

In an embodiment, the polymer may include polyethylene, polypropylene, polystyrene, polyethylene terephthalate, biodegradable polylactic acid polymer, polyvinyl alcohol, polyvinyl chloride, neoprene/chlorosulphonated polyethylene, polyurethane, thermoplastic polyurethane, ethylene vinyl alcohol, polyamide, high density polyethylene (HDPE), medium-density polyethylene (MDPE), low density polyethylene (LDPE), linear low density polyethylene (LLDPE) or any combination thereof.

In an embodiment, the caseinate may be sodium caseinate or calcium caseinate.

In an embodiment, the composition may include the calcium carbonate in an amount of 3 wt % to 80 wt %, based on the total weight of the composition. In one or more embodiments, the composition may include the calcium carbonate in an amount of 75 wt % to 80 wt %, based on the total weight of the composition.

In an embodiment, the composition may include the casein and/or caseinate in an amount of 0.1 wt % to 6 wt %, based on the total weight of the composition.

In an embodiment, the composition may include the calcium propionate in an amount of 0.1 wt % to 6 wt %, based on the total weight of the composition.

In an embodiment, the composition may include a filler that includes talc, nano clays, nanocellulose, hemp fibers, kaolin, carbon black, wollastonite, glass fibers, carbon fibers, graphite fibers, graphene, mica, silica, dolomite, barium sulfate, magnetite, halloysite, zinc oxide, titanium dioxide, montmorillonite, feldspar, asbestos, boron, steel, carbon nanotubes, cellulose fibers, flax, cotton, starch, polysaccharides, aluminum hydroxide, magnesium hydroxide, modified starches, chitins and chitosans, alginates, gluten, zein, collagen, gelatin, polysaccharides, guar gum, xanthan gum, succinoglycan, natural rubbers; rosinic acid, lignins, natural fibers, jute, kenaf, hemp, ground nut shells, wood flour, cellulose, a non-nylon fiber, and/or a non-polyester fiber.

In an embodiment, the composition may include from 5 wt % to 40 wt % of the filler based on the total weight of the composition.

In an embodiment, the composition may include an impact modifier that includes acrylic-based resins and emulsions, isosorbide derivatives, natural rubbers, and/or aliphatic polyesters.

In an embodiment, the composition may include up to 20 wt % of the impact modifier based on the total weight of the composition.

In an embodiment, the composition may include from 5 wt % to 15 wt % of the impact modifier based on the total weight of the composition.

In an embodiment, the packaging material may have a shelf life of 3 to 6 months.

In an embodiment, the packaging material may have a shelf life of greater than 6 months.

According to one or more embodiments of the present disclosure, a method of producing a polymeric packaging material may include forming a composition by combining calcium carbonate (CaCO₃), a polymer, and casein and/or caseinate; and producing the polymeric packaging material from the composition. In one or more embodiments, the composition may further include calcium propionate (C₆H₁₀CaO₄).

In an embodiment, the method may include treating the composition with electron beam irradiation prior to producing the polymeric packaging material from the composition.

In an embodiment, the method may include treating the polymeric packaging material with electron beam irradiation.

In an embodiment, the polymer may include polyethylene, polypropylene, polystyrene, polyethylene terephthalate, biodegradable polylactic acid polymer, polyvinyl alcohol, polyvinyl chloride, neoprene/chlorosulphonated polyethylene, polyurethane, thermoplastic polyurethane, ethylene vinyl alcohol, polyamide, high density polyethylene (HDPE), medium-density polyethylene (MDPE), low density polyethylene (LDPE), linear low density polyethylene (LLDPE) or any combination thereof.

In an embodiment, the caseinate may be sodium caseinate or calcium caseinate.

In an embodiment, the composition may include calcium carbonate in an amount of 3 wt % to 80 wt %, based on the total weight of the composition. In one or more embodiments, the composition may include the calcium carbonate in an amount of 75 wt % to 80 wt %, based on the total weight of the composition.

In an embodiment, the composition may include the casein and/or caseinate in an amount of 0.1 wt % to 6 wt %, based on the total weight of the composition.

In an embodiment, the composition may include the calcium propionate in an amount of 0.1 wt % to 6 wt %, based on the total weight of the composition.

In an embodiment, the composition may include a filler that includes talc, nano clays, nanocellulose, hemp fibers, kaolin, carbon black, wollastonite, glass fibers, carbon fibers, graphite fibers, graphene, mica, silica, dolomite, barium sulfate, magnetite, halloysite, zinc oxide, titanium dioxide, montmorillonite, feldspar, asbestos, boron, steel, carbon nanotubes, cellulose fibers, flax, cotton, starch, polysaccharides, aluminum hydroxide, magnesium hydroxide, modified starches, chitins and chitosans, alginates, gluten, zein, collagen, gelatin, polysaccharides, guar gum, xanthan gum, succinoglycan, natural rubbers; rosinic acid, lignins, natural fibers, jute, kenaf, hemp, ground nut shells, wood flour, cellulose, a non-nylon fiber, and/or a non-polyester fiber.

In an embodiment, the composition may include from 5 wt % to 40 wt % of the filler based on the total weight of the composition.

In an embodiment, the composition may include an impact modifier that includes acrylic-based resins and emulsions, isosorbide derivatives, natural rubbers, and/or aliphatic polyesters.

In an embodiment, the composition may include up to 20 wt % of the impact modifier based on the total weight of the composition.

In an embodiment, the composition may include from 5 wt % to 15 wt % of the impact modifier based on the total weight of the composition.

In an embodiment, the polymeric packaging material may have a shelf life of 3 to 6 months.

In an embodiment, the polymeric packaging material may have a shelf life of greater than 6 months.

In an embodiment, the step of producing the polymeric packaging material from the composition may be selected from any one of the following: injection molding, compression molding, thermoforming, cast and blown film formation, extrusion coating, extrusion blow molding, injection stretch blow molding, and extrusion profiling.

### DETAILED DESCRIPTION

In the following detailed description, only certain embodiments of the subject matter of the present disclosure are described, by way of illustration. As those skilled in the art would recognize, the subject matter of the present disclosure may be embodied in many different forms and should not be construed as being limited to the embodiments set forth herein.

Combining calcium carbonate (CaCO₃), polymer, and casein (and, optionally, further combining calcium propionate (C₆H₁₀CaO₄)) provides a packaging material that results in controlled oxidative degradation with enhanced bio-degradation owing to the chemotactic effects of casein. This material can be used in and has applicability to a wide variety of products.

Casein is surprisingly uniquely suited for this application owing to the fact that it has natural affinity for Ca+, as it is a protein found in mammalian milk. And it is a discovery of the present disclosure that techniques that are currently used in the bread and dairy industry can be optimized to mitigate mold formation (associated with casein) and create a stable compound and product suitable for commercial use.

Reduction of microplastic formation and the life span of such microplastics is expected to be shorter than that of the parent compounds. This, in turn, will limit the negative environmental effects of microplastics.

Transition metal (e.g., manganese, iron, cobalt, cadmium) salts have been added to polymers to enhance polymer oxidation and breakdown with subsequent changes in the polymer as indicated by the presence of carbonyl group formation as determined by FTIR analysis. Carbonyl group formation, in addition to diminished molecular weight of the polymer, are believed to be important in allowing bacterial attack of the polymer. Typically, however, to initiate oxidation and polymer breakdown exposure to UV light is required. In addition, embrittlement and loss of tensile strength, as measured by modulus of elasticity, confirms physical property changes. Concerns about persistent microplastics, with a life span of their parent compounds, have limited the use of transitional metal salts in many parts of the world. In addition, transition metal salts are inorganic compounds with little inherent ability to attract and promote biological activity and breakdown of polymer.

Displacing/replacing polymer with CaCO₃ in packaging has the advantage of decreasing the amount of polymer that is used, and presumably microplastic formation. The use of CaCO₃ in place of polymer should also enhance polymer oxidation and its subsequent breakdown. Furthermore, there are synergistic effects on polymer breakdown with the addition of transition metal salt compounds (and CaCO₃), that are both beneficial and unexpected.

A superior potential additive may have the following properties:

An ability to enhance oxidative breakdown of polymer chain by creating carbonyl group that allows for bacterial attack.

An organic compound that can serve as a chemotactic agent to promote and potentially induce fungal and or microbial colonization and activity to create a more robust and predictable biological breakdown of oxidized polymer. With the goal being to shorten polymer life span in the open environment.

In addition, the additive may have the following properties: i) heat stable at liquid polymer temperatures; ii) can be incorporated into polymer structure to enhance oxidation and carbonyl group formation; iii) readily available; economically viable; iv) food and contact safe; v) not create additional environmental hazards in the process of using it or during the breakdown process.

The milk protein casein is a protein readily available as a byproduct of the milk industry. Caseins are mammalian milk proteins with a loose tertiary, highly hydrated structure. They possess clusters of phosphoserine and phosphothreonine residues that bind amorphous calcium phosphate, which allows milk to contain higher levels of soluble calcium than is possible in ordinary solutions. Thus, casein's structure may be uniquely suited to work in packaging containing CaCO₃. Casein-based nanomaterials have been exploited for the delivery of bioactive substances and nutraceuticals owing to their low cost, stability, biodegradability, and biocompatibility characteristics.

In addition, a potential preservative is also a calcium based compound, calcium propionate (C₆H₁₀CaO₄), and as such may have an affinity for preserving casein.

Moreover, casein alleviates certain transition metal salt concerns, since some transition metal salts are considered toxic (e.g., cadmium). Casein is an organic compound known to be safe as it exists in mammalian milk. Casein has the potential to be a chemotactic agent for microbes, and it is readily available.

Combining CaCO₃, casein and/or caseinate, and polyolefin polymer yields a packaging material with unexpected synergistic effects.

The composition includes CaCO₃ in an amount of 3 wt % to 80 wt %, which includes 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, and 80 wt % based upon the total weight of the composition. The composition includes casein and/or caseinate in an amount of 0.1 wt % to 6 wt %, which includes 1, 2, 3, 4, 5 and 6 wt % based upon the total weight of the composition.

The resulting materials may break down in ambient temperatures of 25° C. without exposure to ultraviolet light (which is typically needed to initiate polymer breakdown) as evidenced by carbonyl group formation as confirmed by FTIR analysis and polymer physical property changes included embrittlement and loss of strength.

Additionally, unlike transition metal salts, fungal formation may occur as early as 4-14 days, suggesting a chemotactic quality to the casein that is not found in other polymer degradation additives. This has the potential to enhance “biodegradation” or “mineralization” of the remaining polymer. Mineralization is the process by which chemicals present in organic matter are decomposed or oxidized into forms that are easily available to plants.

Owing to the organic nature of casein, the processing concepts to produce such packaging may require incorporating some food sterilization concepts to create an acceptably long shelf life to make such product commercially viable. As discussed above, techniques to minimize mold formation and/or fungal formation due to the use of casein may be employed in order to ensure a shelf life of 3 to 6 months or longer.

Methods to control mold can include i) minimizing hydration by heat desiccation or adding a desiccating agent; and ii) adding calcium propionate in an amount of 0.1 wt % to 6 wt %, which includes 0.1, 0.5, 1, 1.5, 2, 2.5, 3, 3.5, 4, 4.5, 5, 5.5 and 6 wt %, based upon the total weight of the composition. The amount depends on effect and the desired shelf life. Calcium propionate is a well-known safe additive in bread. Sodium propionate (C₃H₅NaO₂) may also be used.

Following production of the composition or conversion to a given product or article, a radiation beam sterilization, similar to what is used in meat and dairy processes, may be employed, in order to limit premature mold and or bacterial attack. The effect of such processes may have a retarding effect on degradation and counter act some of the pro-degradant effects of the casein itself. Therefore, to create a packaging with a predictable degradation behavior not only may the % casein be optimized, but the negative effects of mold control may need to be taken into account.

CaCO₃, and any suitable polyolefin polymer (g. HDPE, MDPE, LDPE, LLDPE, polypropylene etc.) may be compounded with casein at 0.1%-6%, and calcium propionate added in amounts of 0.1%-6%, using a twin screw/pelletizing process and packaged to produce a shelf stable product. The resulting composition may be exposed to electron beam radiation, similar to a pasteurization process following pelletization. The type of polymer or polymers chosen ultimately depends on what the packaging material will be used for. For example, packaging for shipping expensive/fragile items need to be more robust than packaging used for shelf storage. The packaging material may be formed by extrusion techniques or forming by, blown film, blow molding, injection molding, thermoforming and/or the like. Numerous techniques should be apparent to one of ordinary skill in the art upon reviewing the present disclosure. An additional, step of electron beam irradiation may be performed following the conversion. Applications may include but are not limited to any product currently being made from a polymer or polymers with a pH>4.5 that does not require transparency. Applications may include milk and dairy containers, chip bags, cups, agricultural film etc.

Advantages of the embodiments of the present disclosure include but are not limited to the reduction in microplastics. While the present application is not limited by any particular mechanism or theory, replacement of 50-65% polymer in packaging may have the potential to reduce microplastics by an equivalent amount. Microplastic life span can potentially be reduced, thereby reducing the negative potential effects of microplastics in the open environment. Again while not wanting to be bound by any theory, the formation of carbonyl groups on polymer breakdown products potentially changes the polarity of plastic from hydrophobic to hydrophilic potentially decreasing attraction and concentration of persistent organic pollutants (POPs) on polymer fragments. By creating a degradable/bio-degradable packaging, the need for recycling is lessened. Furthermore, a bio-degradable product is potentially useful in industrial composting environments.

The process of biodegradation is called mineralization as it is directed to a polymer that is broken down to its mineral component CO₂ and H₂O. Carbon mineralization is the process by which carbon dioxide becomes a solid mineral, such as a carbonate. It is a chemical reaction that happens when certain rocks are exposed to carbon dioxide. Calcium carbonate can be made by biological processes that occur in certain terrestrial species such as birds and reptiles and ocean species including fish and crustaceans. One of the biggest advantages of carbon mineralization is that the carbon cannot escape back to the atmosphere, unless exposed to high temperatures (e.g., 825° C., and/or exposed to a pH of 7 or less (e.g., an acidic pH).

Highly loaded packaging with CaCO₃ is essentially “pre-mineralized” as CaCO₃ is a solid stable form of CO₂ at natural earth temperatures (−20° C. to 121° C.). Therefore, with 65% CaCO₃ and 35% polymer, packaging would have 65% CaCO₃ “mineralization” at time zero. As CaCO₃ is stable no CO₂ escapes unless exposed to acid pH<4.5 or heated to 900° C. Therefore, only 35% of the packaging needs to degrade over time. Therefore, it is expected that this packaging is more likely to completely degrade than its 100% polymer counterpart. The use of CaCO₃ in packaging should reduce the CO₂ foot print more than packaging made without CaCO₃.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, acts, operations, elements, and/or components, but do not preclude the presence or addition of one or more other features, integers, acts, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the terms “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present disclosure, and should not be interpreted in an idealized or overly formal sense, unless expressly so defined herein.

The following two documents are each relied upon and incorporated by reference herein in their entirety. If at any point an incorporated reference conflicts with this written disclosure, this written disclosure controls.
Kit L. Yam (Editor), “The Wiley Encyclopedia of Packaging Technology, 3rd Edition”, ISBN: 978-0-470-08704-6.
Soroka, W and CCP, “Fundamentals of Packaging Technology-Fourth Edition”, ISBN-13: 978-1930268289, ISBN-10: 1930268289.

While the subject matter of the present disclosure has been described in connection with certain embodiments, it is to be understood that the subject matter of the present disclosure is not limited to the disclosed embodiments, but, on the contrary, the present disclosure is intended to cover various modifications and equivalent arrangements included within the spirit and scope of the appended claims, and equivalents thereof.

What is claimed is:

1. A packaging material formed from a composition, wherein the composition comprises:
calcium carbonate (CaCO₃);
a polymer; and
casein and/or caseinate.

2. The packaging material of claim 1, wherein the polymer comprises polyethylene, polypropylene, polystyrene, polyethylene terephthalate, biodegradable polylactic acid polymer, polyvinyl alcohol, polyvinyl chloride, neoprene/chlorosulphonated polyethylene, polyurethane, thermoplastic polyurethane, ethylene vinyl alcohol, polyamide, high density polyethylene (HDPE), medium-density polyethylene (MDPE), low density polyethylene (LDPE), linear low density polyethylene (LLDPE) or any combination thereof.

3. The packaging material of claim 1, wherein the caseinate is sodium caseinate or calcium caseinate.

4. The packaging material of claim 1, wherein the composition comprises the calcium carbonate in an amount of 3 wt % to 80 wt %, based on the total weight of the composition.

5. The packaging material of claim 1, wherein the composition comprises the casein and/or caseinate in an amount of 0.1 wt % to 6 wt %, based on the total weight of the composition.

6. The packaging material of claim 1, wherein the composition further comprises calcium propionate in an amount of 0.1 wt % to 6 wt %, based on the total weight of the composition.

7. The packaging material of claim 1, wherein the composition further comprises a filler comprising talc, nano clays, nanocellulose, hemp fibers, kaolin, carbon black, wollastonite, glass fibers, carbon fibers, graphite fibers, graphene, mica, silica, dolomite, barium sulfate, magnetite, halloysite, zinc oxide, titanium dioxide, montmorillonite, feldspar, asbestos, boron, steel, carbon nanotubes, cellulose fibers, flax, cotton, starch, polysaccharides, aluminum hydroxide, magnesium hydroxide, modified starches, chitins and chitosans, alginates, gluten, zein, collagen, gelatin, polysaccharides, guar gum, xanthan gum, succinoglycan, natural rubbers; rosinic acid, lignins, natural fibers, jute, kenaf, hemp, ground nut shells, wood flour, cellulose, a non-nylon fiber, and/or a non-polyester fiber.

8. The packaging material of claim 7, wherein the composition comprises from 5 wt % to 40 wt % of the filler based on the total weight of the composition.

9. The packaging material of claim 1, wherein the composition further comprises an impact modifier comprising acrylic-based resins and emulsions, isosorbide derivatives, natural rubbers, and/or aliphatic polyesters.

10. The packaging material of claim 9, wherein the composition comprises up to 20 wt % of the impact modifier based on the total weight of the composition.

11. The polymeric composition of claim 10, wherein the composition comprises from 5 wt % to 15 wt % of the impact modifier based on the total weight of the composition.

12. The packaging material of claim 1, wherein the packaging material has a shelf life of 3 to 6 months.

13. The packaging material of claim 1, wherein the packaging material has a shelf life of greater than 6 months.

14. A method of producing a polymeric packaging material comprising:
forming a composition by combining calcium carbonate (CaCO₃), a polymer, and casein and/or caseinate; and
producing the polymeric packaging material from the composition.

15. The method of claim 14, further comprising treating the composition with electron beam irradiation prior to producing the polymeric packaging material from the composition.

16. The method of claim 14, further comprising treating the polymeric packaging material with electron beam irradiation.

17. The method of claim 14, wherein the polymer comprises polyethylene, polypropylene, polystyrene, polyethylene terephthalate, biodegradable polylactic acid polymer, polyvinyl alcohol, polyvinyl chloride, neoprene/chlorosulphonated polyethylene, polyurethane, thermoplastic polyurethane, ethylene vinyl alcohol, polyamide, high density polyethylene (HDPE), medium-density polyethylene (MDPE), low density polyethylene (LDPE), linear low density polyethylene (LLDPE) or any combination thereof.

18. The method of claim 14, wherein the caseinate is sodium caseinate or calcium caseinate.

19. The method of claim 14, wherein the composition comprises the calcium carbonate in an amount of 3 wt % to 80 wt %, based on the total weight of the composition.

20. The method of claim 14, wherein the composition comprises the casein and/or caseinate in an amount of 0.1 wt % to 6 wt %, based on the total weight of the composition.

21. The method of claim 14, wherein the composition further comprises calcium propionate in an amount of 0.1 wt % to 6 wt %, based on the total weight of the composition.

22. The method of claim 14, wherein the composition further comprises a filler comprising talc, nano clays, nanocellulose, hemp fibers, kaolin, carbon black, wollastonite, glass fibers, carbon fibers, graphite fibers, graphene, mica, silica, dolomite, barium sulfate, magnetite, halloysite, zinc oxide, titanium dioxide, montmorillonite, feldspar, asbestos, boron, steel, carbon nanotubes, cellulose fibers, flax, cotton, starch, polysaccharides, aluminum hydroxide, magnesium hydroxide, modified starches, chitins and chitosans, alginates, gluten, zein, collagen, gelatin, polysaccharides, guar gum, xanthan gum, succinoglycan, natural rubbers; rosinic acid, lignins, natural fibers, jute, kenaf, hemp, ground nut shells, wood flour, cellulose, a non-nylon fiber, and/or a non-polyester fiber.

23. The method of claim 22, wherein the composition comprises from 5 wt % to 40 wt % of the filler based on the total weight of the composition.

24. The method of claim 14, wherein the composition further comprises an impact modifier comprising acrylic-based resins and emulsions, isosorbide derivatives, natural rubbers, and/or aliphatic polyesters.

25. The method of claim 24, wherein the composition comprises up to 20 wt % of the impact modifier based on the total weight of the composition.

26. The method of claim 25, wherein the composition comprises from 5 wt % to 15 wt % of the impact modifier based on the total weight of the composition.

27. The method of claim 14, wherein the polymeric packaging material has a shelf life of 3 to 6 months.

28. The method of claim 14, wherein the polymeric packaging material has a shelf life of greater than 6 months.

29. The method of claim 14, wherein the step of producing the polymeric packaging material from the composition is selected from injection molding, compression molding, thermoforming, cast and blown film formation, extrusion coating, extrusion blow molding, injection stretch blow molding, and extrusion profiling.
